(19) United States
(12) Patent Application Publication
(10) Pub. No.: US 2018/0340478 A1
(43) Pub. Date: Nov. 29, 2018

(54) COOLING APPARATUS OF INTERNAL COMBUSTION ENGINE

(71) Applicant: TOYOTA JIDOSHA KABUSHIKI KAISHA, Toyota-shi (JP)

(72) Inventor: Takashi HOTTA, Susono-shi (JP)

(73) Assignee: TOYOTA JIDOSHA KABUSHIKI KAISHA, Toyota-shi (JP)

(21) Appl. No.: 15/989,707

(22) Filed: May 25, 2018

(30) Foreign Application Priority Data
May 29, 2017 (JP) 2017-105235

(51) Int. Cl. F02D 41/00; F02B 29/04; B60W 20/50; B60W 50/038

(52) U.S. Cl. CPC F02D 41/0002; F02B 29/04; F02D 2041/001; B60W 50/038; F02D 2200/0414; B60W 20/50

(57) ABSTRACT

The control apparatus of the engine according to the invention controls an opening timing of each of intake valves to a predetermined opening timing after an intake top dead center when the engine operation starts. The apparatus prohibits the opening timing from advancing from the predetermined opening timing until a total intake air amount correlation value reaches a threshold after the engine operation starts. The apparatus permits the opening timing to advance from the predetermined opening timing after the total intake air amount correlation value reaches the threshold after the engine operation starts.

### BACKGROUND

### Field

The invention relates to a control apparatus of an internal combustion engine for controlling an opening timing or a closing timing of each of intake valves.

### Description of the Related Art

When an engine temperature (i.e., a temperature of the internal combustion engine) is low at a time of an engine operation (i.e., an operation of the engine) starting, friction resistances of movable parts of the engine are large. On the other hand, it is desired to cause the engine to output a large torque.

There is known a control apparatus of the engine configured to increase an amount of an air suctioned into combustion chambers of the engine by advancing opening and closing timings of each of intake valves of the engine and increase, an amount of fuel supplied to the combustion chambers when the engine temperature is low at the time of the engine operation starting (for example, see JP 2009-203828 A).

A relatively large amount of the fuel may adhere to wall surfaces defining intake ports of the engine and/or the combustion chambers (hereinafter, will be collectively referred to as “the port wall surface and the like”) immediately after the engine operation starts. The wall-adhering fuel (i.e., the fuel adhering to the port wall surface and the like) may remove from the port wall surface and the like. However, the removed fuel is unlikely to vaporize. Thus, the removed fuel is unlikely to burn in the combustion chambers even by increasing the amount of the air suctioned into the combustion chamber when the engine temperature is low at the time of the engine operation starting. Therefore, the removed fuel is likely to be discharged as unburned fuel from the combustion chambers.

In this case, a large amount of the unburned fuel may be discharged from the combustion chambers. As a result, an amount of exhaust emission may increase. Thus, it is desired to vaporize the removed fuel sufficiently in order to prevent the large amount of the unburned fuel from being discharged from the combustion chambers.

### SUMMARY

The invention has been made for solving the above-described problems. An object of the invention is to provide a control apparatus of the engine for removing the wall-adhering fuel from the port wall surface and the like and vaporize the removed fuel sufficiently when the engine operation starts.

A control apparatus of an internal combustion engine (10) according to the first invention comprises an electronic control unit (90) for controlling an opening timing (Top) of each of intake valves of the internal combustion engine (10), depending on an operation state of the internal combustion engine (10) (see processes of a step 840 in FIG. 8 and a step 1030 in FIG. 10) after an engine operation corresponding to an operation of the internal combustion engine (10), starts (see determinations “Yes” at a step 810 in FIG. 8 and a step 1005 in FIG. 10).

The electronic control unit (90) is configured to control the opening timing (Top) to a predetermined opening timing after an intake top dead center when the engine operation starts.

The electronic control unit (90) is further configured to acquire a total intake air amount correlation value correlating with a total amount (ΣGa) of air suctioned into combustion chambers (25) of the internal combustion engine (10) after the engine operation starts. The total air amount correlation value increases as the total amount (ΣGa) increases.

The electronic control unit (90) is further configured to prohibit the opening timing (Top) from advancing from the predetermined opening timing (see a process of a step 780 in FIG. 7, a determination “No” at a step 820 in FIG. 8, a determination “No” at a step 1015 in FIG. 10, and a process of a step 1040 in FIG. 10) until the total intake air amount correlation value reaches a threshold after the engine operation starts (see a determination “No” at a step 750 in FIG. 7).

On the other hand, the electronic control unit (90) is further configured to permit the opening timing (Top) to advance from the predetermined opening timing (see a process of a step 760 in FIG. 7, a determination “Yes” at the step 820 in FIG. 8, the process of the step 840 in FIG. 8, a determination “Yes” at the step 1015 in FIG. 10, and the process of a step 1030 in FIG. 10) after the total intake air amount correlation value reaches the threshold (see a determination “Yes” at the step 750 in FIG. 7) after the engine operation starts (see a determination “Yes” at a step 710 in FIG. 7).

As described above, the wall-adhering fuel (i.e., the fuel adhering to the port wall surface and the like) is unlikely to vaporize when the wall-adhering fuel removes from the port wall surface and the like immediately after the engine operation starts. Therefore, the removed fuel (i.e., the fuel removed from the port wall surface and the like) is likely to be discharged from the combustion chambers as unburned fuel without burning in the combustion chambers. Thus, it is preferred to remove the wall-adhering fuel from the port wall surface and the like and vaporize the removed fuel sufficiently in order to prevent a large amount of the unburned fuel derived from the removed fuel, from being discharged from the combustion chamber.

In general, an intake air flow speed (i.e., a flow speed of an air suctioned into the combustion chambers) is high when the intake valve opening timing (i.e., the opening timing of each of the intake valves) is delayed after the intake top dead center, compared with when the intake valve opening timing is advanced after the intake top dead center. The removed fuel (i.e., the wall-adhering fuel removed from the port wall surface and the like) is likely to vaporize sufficiently when the intake air flow speed is high, compared with when the intake air flow speed is low.

The control apparatus according to the first invention prohibits the intake valve opening timing from advancing from the predetermined opening timing until the total intake air amount correlation value reaches the threshold after the engine operation starts. Therefore, the intake valve opening timing is maintained at a delayed timing after the intake top dead center, compared with the intake valve opening timing is advanced from the predetermined opening timing. As a result, the intake air flow speed is maintained high. Thus, the removed fuel may vaporize sufficiently.

According to an aspect of the first invention, the electronic control unit (90) may be configured to control the opening timing (Top) in a predetermined first range in which a most delayed opening timing (Top_rtd) is after the intake top dead center. In this case, the electronic control unit (90) may be configured to set the predetermined opening timing to the most delayed opening timing (Top_rtd) of the predetermined first range (see the process of the step 1040 in FIG. 10) when the engine operation starts and control the opening timing (Top) to the predetermined opening timing.

According to this aspect, the intake valve opening timing is maintained at the most delayed opening timing after the intake top dead center until the total intake air amount correlation value reaches the threshold after the engine operation starts. As a result, the intake air flow speed further increases. Thus, the removed fuel may vaporize sufficiently.

According to a further aspect of the first invention, the electronic control unit (90) may be configured to control a closing timing (Tcl) of each of the intake valves (32), depending on the operation state of the internal combustion engine (10) (see the processes of the step 840 in FIG. 8 and the step 1030 in FIG. 10) after the engine operation starts (see the determinations “Yes” at the step 810 in FIG. 8 and the step 1015 in FIG. 10).

In this case, the electronic control unit (90) may be configured to control the closing timing (Tcl) to a predetermined closing timing after an intake bottom dead center when the engine operation starts.

In this case, the electronic control unit (90) may be configured to prohibit the closing timing (Tcl) from advancing from the predetermined closing timing (see the process of the step 780 in FIG. 7, the determination “No” at the step 820 in FIG. 8, the determination “No” at the step 1015 in FIG. 10, and the process of the step 1040 in FIG. 10) until the total intake air amount correlation value reaches the threshold (see the determination “No” at the step 750 in FIG. 7) after the engine operation starts (see the determination “Yes” at the step 710 in FIG. 7).

In this case, the electronic control unit (90) may be configured to permit the closing timing (Tcl) to advance from the predetermined closing timing (the process of the step 760 in FIG. 7, the determination “Yes” at the step 820 in FIG. 8, the process of the step 840 in FIG. 8, the determination “Yes” at the step 1015 in FIG. 10, and the process of the step 1030 in FIG. 10) after the total intake air amount correlation value reaches the threshold after the engine operation starts (see the determination “Yes” at the step 750 in FIG. 7).

When the intake valve closing timing is the predetermined closing timing after the intake bottom dead center, the air is returned to the intake ports from the combustion chambers by pistons moving toward the compression top dead center. The returned air (i.e., the air returned to the intake ports) may remove the wall-adhering fuel from the port wall surface and the like and vaporize the removed fuel sufficiently. In this regard, an amount of the wall-adhering fuel removed from the port wall surface and the like by the returned air, increases as an amount of the returned air increases. In this regard, the amount of the returned air is large when the intake valve closing timing (i.e., the closing timing of each of the intake valves) is delayed after the intake bottom dead center, compared with when the intake valve closing timing is advanced after the intake bottom dead center.

The control apparatus according this aspect of the first invention prohibits the intake valve closing timing from advancing from the predetermined closing timing until the total intake air amount correlation value reaches the threshold after the engine operation starts. Therefore, the intake valve closing timing is maintained at a delayed timing after the intake bottom dead center, compared with when the intake valve closing timing is advanced from the predetermined closing timing. As a result, the amount of the returned air is maintained large. Thus, a large amount of the removed fuel (i.e., the wall-adhering fuel removed from the port wall surface and the like) may vaporize sufficiently.

According to a further aspect of the first invention, the electronic control unit (90) may be configured to control the closing timing (Tcl) in a predetermined second range in which a most delayed closing timing (Tcl_rtd) is after the intake bottom dead center. In this case, the electronic control unit (90) may be configured to set the predetermined closing timing to the most delayed closing timing (Tcl_rtd) of the predetermined second range when the engine operation starts and control the closing timing (Tcl) to the predetermined opening timing (see the process of the step 1040 in FIG. 10).

According to this aspect, the intake valve closing timing is maintained at the most delayed closing timing after the intake bottom dead center until the total intake air amount correlation value reaches the threshold after the engine operation starts. As a result, the amount of the returned air increases. Thus, the large amount of the removed fuel may vaporize sufficiently.

A control apparatus of the internal combustion engine (10) according to a second invention comprises an electronic control unit (90) for controlling a closing timing (Tcl) of each of intake valves (32) of the internal combustion engine (10), depending on an operation state of the internal combustion engine (10) (see the processes of the step 840 in FIG. 8 and the step 1030 in FIG. 10) after an engine operation corresponding to an operation of the internal combustion engine (10), starts (see the determinations “Yes” at the step 810 in FIG. 8 and the step 1015 in FIG. 10).

The electronic control unit (90) according to the second invention is configured to control the closing timing (Tcl) to a predetermined closing timing after an intake bottom dead center when the engine operation starts.

The electronic control unit (90) according to the second invention is further configured to acquire a total intake air amount correlation value correlating with a total amount (ΣGa) of air suctioned into combustion chambers (25) of the internal combustion engine (10) after the engine operation starts. The total air amount correlation value increases as the total amount (ΣGa) increases.

The electronic control unit (90) according to the second invention is further configured to prohibit the closing timing (Tcl) from advancing from the predetermined closing timing (see the process of a step 780 in FIG. 7, the determination “No” at the step 820 in FIG. 8, the determination “No” at the step 1015 in FIG. 10, and the process of the step 1040 in FIG. 10) until the total intake air amount correlation value reaches a threshold (see the determination “No” at the step 750 in FIG. 7) after the engine operation starts (see the determination “Yes” at the a step 710 in FIG. 7).

The electronic control unit (90) according to the second invention is further configured to permit the closing timing (Tcl) to advance from the predetermined closing timing (see the process of the step 760 in FIG. 7, the determination “Yes” at the step 820 in FIG. 8, the process of the step 840 in FIG. 8, the determination “Yes” at the step 1015 in FIG. 10, and the process of the step 1030 in FIG. 10) after the total intake air amount correlation value reaches the threshold (see the determination “Yes” at the step 750 in FIG. 7) after the engine operation starts (see the determination “Yes” at the step 710 in FIG. 7).

The control apparatus according to the second invention prohibits the intake valve closing timing from advancing from the predetermined closing timing until the total intake air amount correlation value reaches the threshold after the engine operation starts. Therefore, for the same reasons described above, the large amount of the removed fuel may vaporize sufficiently.

According to an aspect of any of the first and second inventions, the electronic control unit (90) may be configured to set the threshold to a large value (see a process of a step 730 in FIG. 7) when a temperature of the internal combustion engine is low at a time of the engine operation starting, compared with when the temperature of the internal combustion engine is high at the time of the engine operation starting.

The fuel is unlikely to vaporize when the engine temperature (i.e., the temperature of the internal combustion engine) is low, compared with when the engine temperature is high. According to this aspect, the threshold used for determining whether the intake valve opening or closing timing should be prohibited from being advanced, is set to the large value when the engine temperature is low, compared with when the engine temperature is high. Thus, the removed fuel may vaporize sufficiently while the intake valve opening or closing timing is prohibited.

According to an aspect of any of the first and second inventions, the electronic control unit (90) may be configured to set the threshold to a large value (see the process of the step 730 in FIG. 7) when an amount of fuel supplied to the combustion chambers (25) is large at a time of the engine operation starting, compared with when the amount of the fuel supplied to the combustion chambers (25) is small at the time of the engine operation starting.

The amount of the fuel adhered to the port wall surface and the like is large when the supplied fuel amount (i.e., the amount of the fuel supplied to the combustion chambers of the internal combustion engine) is large, compared with when the supplied fuel amount is small. According to this aspect, the threshold used for determining whether the intake valve opening or closing timing should be prohibited from being advanced, is set to the large value when the supplied fuel amount is large, compared with when the supplied fuel amount is small. Thus, the removed fuel may vaporize sufficiently while the intake valve opening or closing timing is prohibited.

In the above description, for facilitating understanding of the present invention, elements of the present invention corresponding to elements of an embodiment described later are denoted by reference symbols used in the description of the embodiment accompanied with parentheses. However, the elements of the present invention are not limited to the elements of the embodiment defined by the reference symbols. The other objects, features, and accompanied advantages of the present invention can be easily understood from the description of the embodiment of the present invention along with the drawings.

### BRIEF DESCRIPTION OF THE DRAWINGS

FIG. 1 is a view for showing a hybrid vehicle having a vehicle driving apparatus, to which a control apparatus according to the first embodiment of the invention is applied.

FIG. 2 is a view for showing an internal combustion engine shown in FIG. 1.

FIG. 3 is a view for showing a control section of the control apparatus according to the first embodiment.

FIG. 4 is a view for showing a range of changing an opening timing and a closing timing of each of intake valves by a valve timing changing mechanism.

FIG. 5 is a view for showing time chart used for describing a control executed by the control apparatus according to the first embodiment when an operation of the internal combustion engine is requested to be stopped.

FIG. 6 is a flowchart of a routine executed by a CPU of a hybrid ECU of a control section of the control apparatus according to the first embodiment.

FIG. 7 is a flowchart of a routine executed by the CPU of the hybrid ECU.

FIG. 8 is a flowchart of a routine executed by a CPU of an engine ECU of the control section of the control apparatus according to the first embodiment.

FIG. 9 is a view for showing the control section of the control apparatus according to the second embodiment of the invention.

FIG. 10 is a flowchart of a routine executed by the CPU of the hybrid ECU of the control section of the control apparatus according to the second embodiment.

### DESCRIPTION OF THE PREFERRED EMBODIMENTS

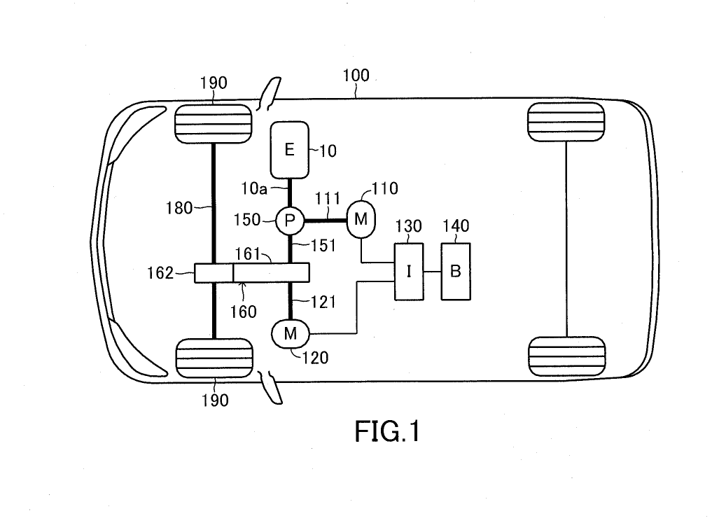

Below, a control apparatus of an internal combustion engine according to an embodiment of the invention will be described with reference to the drawings. The control apparatus according to the first embodiment is applied to an internal combustion engine 10 mounted on a hybrid vehicle 100 shown in FIG. 1. Hereinafter, the control apparatus according to the first embodiment will be referred to as “the first embodiment apparatus”.

The vehicle 100 has a vehicle driving apparatus including the engine 10, a first motor generator 110, a second motor generator 120, an inverter 130, a rechargeable battery 140, a driving force distribution mechanism 150, and a driving force transmission mechanism 160.

The driving force distribution mechanism 150 distributes an engine torque into a torque for rotating an output shaft 151 of the driving force distribution mechanism 150 and a torque for driving the first motor generator 110 as an electric generator at a predetermined distribution property. The engine torque is a torque output from the engine 10.

The driving force distribution mechanism 150 has a planetary gear mechanism (not shown). The planetary gear mechanism has a sun gear, pinion gears, a planetary carrier, and a ring gear.

A rotation shaft of the planetary carrier is connected to an output shaft 10a of the engine 10 and transmits the engine torque to the sun gear and the ring gear via the pinion gears. A rotation shaft of the sun gear is connected to a rotation shaft 111 of the first motor generator 110 and transmits the engine torque from the sun gear to the first motor generator 110. The first motor generator 110 is rotated by the engine torque transmitted from the sun gear, thereby generating electric power. A rotation shaft of the ring gear is connected to the output shaft 151 of the driving force distribution mechanism 150. The engine torque input to the ring gear is transmitted from the driving force distribution mechanism 150 to the driving force transmission mechanism 160 via the output shaft 151.

The driving force transmission mechanism 160 is connected to the output shaft 151 of the driving force distribution mechanism 150 and a rotation shaft 121 of the second motor generator 120. The driving force transmission mechanism 160 includes a reduction gear train 161 and a differential gear 162.

The reduction gear train 161 is connected to a vehicle wheel drive shaft 180 via the differential gear 162. Therefore, the engine torque input from the output shaft 151 of the driving force distribution mechanism 150 to the driving force transmission mechanism 160 and a torque input from the rotation shaft 121 of the second motor generator 120 to the driving force transmission mechanism 160 are transmitted to left and right front driving wheels 190 via the wheel drive shaft 180. The driving force distribution mechanism 150 and the driving force transmission mechanism 160 are known (for example, see JP 2013-177026 A). In this regard, driving wheels may be left and right rear wheels or left and right front and rear wheels.

The first and second motor generators 110 and 120 are permanent magnet synchronous motors, respectively connected to the inverter 130.

The first motor generator 110 is mainly used as an electric generator. The first motor generator 110 performs a cranking of the engine 10 in order to start an engine operation (i.e., an operation of the engine 10). Further, the first motor generator 110 generates a braking torque in a direction opposite to a rotation direction of the engine 10 for stopping the engine operation promptly.

The second motor generator 120 is mainly used as an electric motor and generates a torque for traveling the vehicle 100.

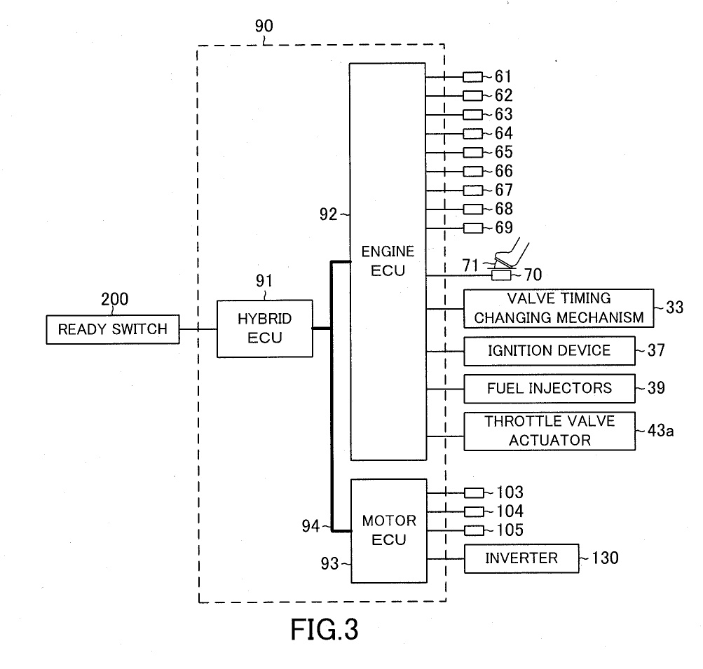

As shown in FIG. 3, the control section 90 of the first embodiment apparatus includes a hybrid ECU 91, an engine ECU 92, and a motor ECU 93. The ECU is an electronic control unit and is an electronic control circuit including as a main component a microcomputer including a CPU, a ROM, a RAM, an interface and the like. The CPU realizes various functions described later by executing instructions or routines stored in a memory, i.e., the ROM.

The hybrid ECU 91, the engine ECU 92, and the motor ECU 93 are electrically connected to send and receive data to and from each other via a communication/sensor CAN (i.e., a communication/sensor Controller Area Network). The hybrid ECU 91, the engine ECU 92, and the motor ECU 93 may be integrated to two or one ECU.

The inverter 130 is electrically connected to the motor ECU 93. An activation of the inverter 130 is controlled by the motor ECU 93. The motor ECU 93 controls activations of the first motor generator 110 and the second motor generator 120 by controlling the activation of the inverter 130 in response to a command sent from the hybrid ECU 91.

The inverter 130 converts direct current power supplied from the battery 140 to three-phase alternate current power and supplies the three-phase alternate current power to the first motor generator 110 in order to activate the first motor generator 110 as the motor. The inverter 130 converts the direct current power supplied from the battery 140 to the three-phase alternate current power and supplies the three-phase alternate current power to the second motor generator 120 in order to activate the second motor generator 120 as the motor.

When the rotation shaft 111 of the first motor generator 110 is rotated by outside force such as a moving energy of the vehicle 100 and the engine torque, the first motor generator 110 is activated as the electric generator to generate electric power. When the first motor generator 110 is activated as the electric generator, the inverter 130 converts the three-phase alternate current power generated by the first motor generator 110 to the direct current power and stores the direct current power in the battery 140.

When the moving energy of the vehicle 100 is input to the first motor generator 110 as the outside force via the driving wheels 190, the vehicle wheel drive shaft 180, the driving force transmission mechanism 160, and the driving force distribution mechanism 150, a regeneration braking force (i.e., a regeneration braking torque) is applied to the driving wheels 190 by the first motor generator 110.

When the rotation shaft 121 of the second motor generator 120 is rotated by the outside force, the second motor generator 120 is activated as the electric generator to generate electric power. When the second motor generator 120 is activated as the electric generator, the inverter 130 converts the three-phase alternate current power generated by the first motor generator 110 to the direct current power and stores the direct current power in the battery 140.

When the moving energy of the vehicle 100 is input to the second motor generator 120 as the outside force via the driving wheels 190, the vehicle wheel drive shaft 180, and the driving force transmission mechanism 160, the regeneration braking force (i.e., the regeneration braking torque) is applied to the driving wheels 190 by the second motor generator 120.

A battery sensor 103, a first rotation angle sensor 104, and a second rotation angle sensor 105 are electrically connected to the motor ECU 93.

The battery sensor 103 includes a current sensor, a voltage sensor and a temperature sensor. The current sensor of the battery sensor 103 detects current flowing into the battery 140 or current flowing out from the battery 140 and outputs a signal representing the current to the motor ECU 93. The voltage sensor of the battery sensor 103 detects voltage of the battery 140 and outputs a signal representing the voltage to the motor ECU 93. The temperature sensor of the battery sensor 103 detects a temperature of the battery 140 and sends a signal representing the temperature to the motor ECU 93.

The motor ECU 93 acquires an electric power amount SOC stored in the battery 140 by a known technique on the basis of the signals sent from the current, voltage, and temperature sensors. Hereinafter, the electric power amount SOC will be referred to as “the battery charge amount SOC”.

The first rotation angle sensor 104 detects a rotation angle of the first motor generator 110 and sends a signal representing the rotation angle to the motor ECU 93. The motor ECU 93 acquires a rotation speed NM1 of the first motor generator 110 on the basis of the signal. Hereinafter, the rotation speed NM1 will be referred to as “the first motor generator rotation angle NM1”.

The second rotation angle sensor 105 detects a rotation angle of the second motor generator 120 and sends a signal representing the rotation angle to the motor ECU 93. The motor ECU 93 acquires a rotation speed NM2 of the second motor generator 120 on the basis of the signal. Hereinafter, the rotation speed NM2 will be referred to as “the second motor generator rotation angle NM2”.

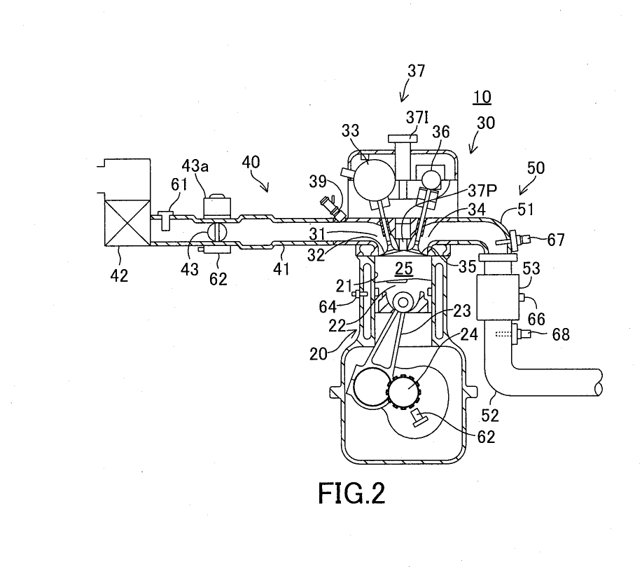

As shown in FIG. 2, the engine 10 is a multi-cylinder (in this embodiment, linear-four-cylinder) four-cycle piston-reciprocation spark-ignition gasoline engine. In this regard, the engine 10 may be a multi-cylinder four-cycle piston-reciprocation compression-ignition diesel engine. FIG. 2 shows a cross section of one of the cylinders, however, each of the remaining cylinders has the same configuration.

The engine 10 includes a cylinder block portion 20, a cylinder head portion 30, an intake system 40, and an exhaust system 50. The cylinder block portion 20 includes a cylinder block, a cylinder block lower case, an oil pan and the like. The cylinder head portion 30 is mounted on the cylinder block portion 20. The engine 10 further includes fuel injectors 39.

The cylinder block portion 20 includes cylinders 21, pistons 22, connection roads 23, and a crank shaft 24. Each of the pistons 22 moves reciprocally in the corresponding cylinder 21. The reciprocating movements of the pistons 22 are transmitted to the crank shaft 24 via the connection roads 23. Thereby, the crank shaft 24 is rotated. A space defined by each of the cylinders 21, a head portion of each of the pistons 22, and the cylinder head portion 30 forms a combustion chamber 25.

The cylinder head portion 30 includes two intake ports 31 communicating with each of the combustion chambers 25 and two intake valves 32 for opening and closing the intake ports 31. FIG. 2 shows only one of the intake ports 31 and one of the intake valves 32. Further, the cylinder head portion 30 includes two exhaust ports 34 communicating with each of the combustion chambers 25, two exhaust valves 35 for opening and closing the exhaust ports 34 and an exhaust cam shaft 36 for driving the exhaust valves 35. FIG. 2 shows only one of the exhaust ports 34 and one of the exhaust valves 35.

The cylinder head portion 30 includes a valve timing changing mechanism 33 for changing an intake valve opening timing Top (i.e., an opening timing Top of each of the intake valves 32). The valve timing changing mechanism 33 is configured to change the intake valve opening timing Top by changing a rotation phase of an intake cam shaft (not shown) for driving the intake valves 32 by a pressure of hydraulic oil. Detailed configuration of the valve timing changing mechanism 33 is, for example, described in JP 2016-200135.

In this embodiment, the valve timing changing mechanism 33 changes the rotation phase of the intake cam shaft as desired when the pressure Poil of the hydraulic oil is equal to or higher than a threshold hydraulic pressure Poil_th. Hereinafter, the pressure Poil will be referred to as “the hydraulic oil pressure Poil”. The hydraulic oil used for changing the rotation phase of the intake cam shaft is supplied to the valve timing changing mechanism 33 by a hydraulic oil pump driven by an output of the engine 10. Therefore, when an operation of the engine 10 is stopped, an activation of the hydraulic oil pump is stopped. Thus, no hydraulic oil is supplied to the valve timing changing mechanism 33. In this case, the intake valve opening timing Top become an opening timing Top_rtd which is most delayed timing which can be accomplished by the valve timing changing mechanism 33.

In this embodiment, when the intake valve opening timing Top is advanced by a predetermined crank angle ΔCA by the valve timing changing mechanism 33, an intake valve closing timing Tcl (i.e., a closing timing Tcl of each of the intake valves 32) is advanced by the ΔCA.

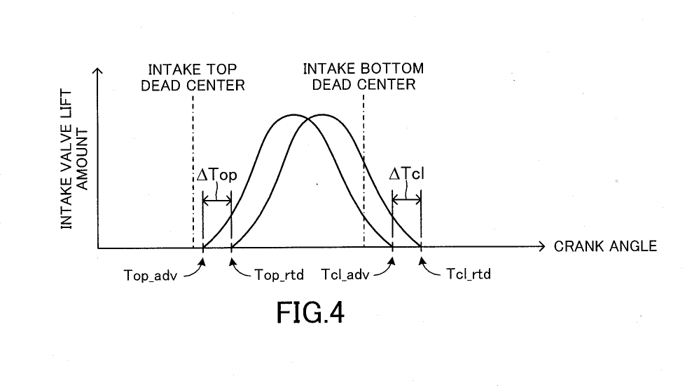

As shown in FIG. 4, the valve timing changing mechanism 33 may change the intake valve opening timing Top in a range between a most advanced opening timing Top_adv and the most delayed opening timing Top_rtd.

In this embodiment, the most advanced and delayed opening timings Top_adv and Top_rtd are after an intake top dead center. In particular, the most advanced opening timing Top_adv is crank angle 5 degrees after the intake top dead center, and the most delayed opening timing Top_rtd is crank angle 25 degrees after the intake top dead center.

When the intake valve opening timing Top is controlled to the most advanced opening timing Top_adv, the intake valve closing timing Tcl is controlled to a most advanced closing timing Tcl_adv. On the other hand, when the intake valve opening timing Top is controlled to the most delayed opening timing Top_rtd, the intake valve closing timing Tcl is controlled to a most delayed closing timing Tcl_rtd.

In this embodiment, the most advanced closing timing Tcl_adv and the most delayed closing timing Tcl_rtd are after the intake bottom dead center. In particular, the most advanced closing timing Tcl_adv is crank angle 45 degrees after the intake bottom dead center, and the most delayed closing timing Tcl_rtd is crank angle 65 degrees after the intake bottom center.

Further, the cylinder head portion 30 includes an ignition device 37 for generating sparks for igniting fuel in the combustion chambers 25. The ignition device 37 includes ignitor 37I including ignition plugs 37P and ignition coils for generating high voltage to be supplied to the ignition plugs 37P.

Each of the fuel injectors 39 is provided for injecting the fuel into the corresponding intake port 31. The fuel is supplied to the fuel injectors 39 from a fuel tank (not shown).

The intake system 40 includes an intake pipe 41, an air filter 42, a throttle valve 43, and a throttle valve actuator 43a. The intake pipe 41 includes an intake manifold communicating with the intake ports 31. The air filter 42 is provided at an end of the intake pipe 41. The throttle valve 43 is provided in the intake pipe 41 for changing an intake opening area. The throttle valve actuator 43a activates the throttle valve 43. The intake ports 31 and the intake pipe 41 define an intake passage.

The exhaust system 50 includes an exhaust manifold 51, an exhaust pipe 52, and a three-way catalyst 53. The exhaust manifold 51 communicates with the exhaust ports 34. The exhaust pipe 52 is connected to the exhaust manifold 51. The catalyst 53 is provided in the exhaust pipe 52. The exhaust ports 34, the exhaust manifold 51, and the exhaust pipe 52 define an exhaust passage.

The catalyst 53 is a three-way catalytic apparatus (i.e., an exhaust gas purification catalyst) which carries active components comprising noble metal such as platinum. The catalyst 53 oxidizes unburned components such as hydrocarbon (HC) and carbon monoxide (CO) and reduces nitrogen oxide (NOx) when an air-fuel ratio of a gas flowing into the catalyst 53 is stoichiometric air-fuel ratio.

Further, the catalyst 53 has an oxygen storage ability of storing or adsorbing oxygen therein and thus, can purify the unburned components and the nitrogen oxide even when the air fuel ratio of the gas flowing into the catalyst 53 deviates from the stoichiometric air-fuel ratio. The oxygen storage ability is derived from ceria (CeO₂) carried on the catalyst 53.

As shown in FIG. 3, the ignition device 37, the fuel injectors 39, and the throttle valve actuator 43a are electrically connected to the engine ECU 92. As described later, activations of the ignition device 37, the fuel injectors 39, and the throttle valve actuator 43a are controlled by the engine ECU 92.

The engine 10 includes an air flow meter 61, a throttle position sensor 62, a crank position sensor 63, a water temperature sensor 64, a vehicle speed sensor 65, a temperature sensor 66, an air-fuel ratio sensor 67, an air-fuel ratio sensor 68, a hydraulic pressure sensor 69, and the like. The sensors 61, 62, 63, 64, 65, 66, 67, 68, and 69 and the like are electrically connected to the engine ECU 92.

The air flow meter 61 detects a mass flow rate Ga (i.e., an intake air flow rate Ga) flowing through the intake pipe 41 and sends a signal representing the mass flow rate Ga to the engine ECU 92. The engine ECU 92 acquires the mass flow rate Ga on the basis of the signal.

The throttle position sensor 62 detects an opening degree TA of the throttle valve 43 and sends a signal representing the opening degree TA to the engine ECU 92. The engine ECU 92 acquires the opening degree TA on the basis of the signal. Hereinafter, the opening degree TA will be referred to as “the throttle valve opening degree TA”.

The crank position sensor 63 sends a pulse signal each time the crank shaft 24 rotates by a predetermined angle to the engine ECU 92. The engine ECU 92 acquires a rotation speed NE of the engine 10 on the basis of the pulse signals. Hereinafter, the rotation speed NE will be referred to as “the engine speed NE”.

The water temperature sensor 64 detects a temperature THW of cooling water for cooling the engine 10 and sends a signal representing the temperature THW to the engine ECU 92. The engine ECU 92 acquires the temperature THW on the basis of the signal. Hereinafter, the temperature THW will be referred to as “the water temperature THW”.

The vehicle speed sensor 65 detects a moving speed V of the vehicle 100 and sends a signal representing the moving speed V to the engine ECU 92. The engine ECU 92 acquires the moving speed Von the basis of the signal. Hereinafter, the moving speed V will be referred to as “the vehicle speed V”.

The temperature sensor 66 is provided in the catalyst 53. The temperature sensor 66 detects a temperature Tcat of the catalyst 53 and sends a signal representing the temperature Tcat to the engine ECU 92. The engine ECU 92 acquires the temperature Tcat on the basis of the signal. Hereinafter, the temperature Tcat will be referred to as “the catalyst temperature Tcat”.

As shown in FIG. 2, the air-fuel ratio sensor 67 is provided in the exhaust manifold 51 upstream of the catalyst 53. The air-fuel ratio sensor 67 detects an air-fuel ratio A/Fu of an exhaust gas discharged from the combustion chambers 25 and sends a signal representing the air-fuel ratio A/Fu to the engine ECU 92. The engine ECU 92 acquires the air-fuel ratio A/Fu of the exhaust gas discharged from the combustion chambers 25 on the basis of the signal.

The air-fuel ratio sensor 68 is provided in the exhaust pipe 52 downstream of the catalyst 53. The air-fuel ratio sensor 68 detects an air-fuel ratio A/Fd of the exhaust gas flowing out from the catalyst 53 and sends a signal representing the air-fuel ratio A/Fd to the engine ECU 92. The engine ECU 92 acquires the air-fuel ratio A/Fd of the exhaust gas flowing out from the catalyst 53 on the basis of the signal.

The hydraulic pressure sensor 69 detects the pressure Poil of the hydraulic oil supplied to the valve timing changing mechanism 33 and sends a signal representing the pressure Poil to the engine ECU 92. The engine ECU 92 acquires the pressure Poil on the basis of the signal. Hereinafter, the pressure Poil will be referred to as “the hydraulic oil pressure Poil”.

An acceleration pedal operation amount sensor 70 is electrically connected to the engine ECU 92. The acceleration pedal operation amount sensor 70 detects an operation amount AP of an acceleration pedal 71 operated by a driver of the vehicle 100 and sends a signal representing the operation amount AP to the engine ECU 92. The engine ECU 92 acquires the operation amount AP on the basis of the signal. Further, the engine ECU 92 acquires a load KL of the engine 10 on the basis of the signal or the acquired operation amount AP. Hereinafter, the operation amount AP will be referred to as “the acceleration pedal operation amount AP”, and the load KL will be referred to as “the engine load KL”.

A ready switch 200 is electrically connected to the hybrid ECU 91. When the ready switch 200 is set to an ON position, the ready switch 200 sends a high signal to the hybrid ECU 91. When the hybrid ECU 91 receives the high signal, the hybrid ECU 91 determines that the vehicle 100 is permitted to move. On the other hand, when the ready switch 200 is set to an OFF position, the ready switch 200 sends a low signal to the hybrid ECU 91. When the hybrid ECU 91 receives the low signal, the hybrid ECU 91 determines that the vehicle 100 is prohibited from moving.

### Summary of Operation of First Embodiment Apparatus

Below, a summary of an operation of the first embodiment apparatus will be described. As described below, the first embodiment apparatus controls the operation of the engine 10, and the activations of the first motor generator 110 and the second motor generator 120.

### Hybrid Control

Setting of a target engine torque TQeng_tgt, a target engine speed NEtgt, a target first motor generator torque TQmg1_tgt, and a target second motor generator torque TQmg2_tgt, and the like executed by the first embodiment apparatus when the ready switch 200 is set to the ON position, will be described.

The target engine torque TQeng is a target of a torque TQeng to be output from the engine 10. The target engine speed NEtgt is a target of the engine speed NE. The target first motor generator torque TQmg1_tgt is a target of a torque TQmg1 to be output from the first motor generator 110. The target second motor generator torque TQmg2_tgt is a target of a torque TQmg2 to be output from the second motor generator 120.

When the ready switch 200 is set to the ON position, that is, when the vehicle 100 is permitted to move, the hybrid ECU 91 of the first embodiment apparatus acquires a requested torque TQreq on the basis of the acceleration pedal operation amount AP and the vehicle speed V. The requested torque TQreq is a torque requested by the driver as a driving torque applied to the driving wheels 190 for driving the driving wheels 190.

The hybrid ECU 91 calculates an output Pdrv to be input to the driving wheels 190 by multiplying the requested torque TQreq by the second motor generator rotation speed NM2. Hereinafter, the output Pdrv will be referred to as “the requested driving output Pdrv”.

The hybrid ECU 91 acquires an output Pchg to be input to the first motor generator 110 for causing the battery charge amount SOC to approach a target SOCtgt of the battery charge amount SOC on the basis of a difference ΔSOC between the target SOCtgt of the battery charge amount SOC and the present battery charge amount SOC (ΔSOC=SOCtgt−SOC). Hereinafter, the output Pchg will be referred to as “the requested charge output Pchg”, and the target SOCtgt will be referred to as “the target charge amount SOCtgt”.

The hybrid ECU 91 calculates a sum of the requested driving output Pdrv and the requested charge output Pchg as an output Peng_req to be output from the engine 10. Hereinafter, the output Peng_req will be referred to as “the requested engine output Peng_req”.

The hybrid ECU 91 determines whether the requested engine output Peng_req is smaller than a minimum engine output Peng_min (i.e., a lower limit Peng_min of an optimal operation output of the engine 10). The minimum engine output Peng_min is a minimum value of the engine output in which the engine 10 operates at an efficiency larger than a predetermined efficiency. The optimal operation output is defined by an optimal engine torque TQopt and an optimal engine speed NEopt.

When the requested engine output Peng_req is smaller than the minimum engine output Peng_min, the hybrid ECU 91 determines whether conditions C1 to C3 are satisfied.

Condition C1: The battery charge amount SOC is equal to or larger than a threshold charge amount SOCth.

Condition C2: Warming of an interior of the vehicle 100 is not requested.

Condition C3: The catalyst temperature Tcat is equal to or higher than a threshold activation temperature Tcat_th.

The hybrid ECU 91 determines that an engine stop condition is satisfied when the conditions C1 to C3 are satisfied. On the other hand, the hybrid ECU 91 determines that an engine operation condition is satisfied when any of the conditions C1 to C3 is not satisfied. Further, the hybrid ECU 91 determines that the engine operation condition is satisfied when the requested engine output Peng_req is equal to or larger than the minimum engine output Peng_min.

### Engine Operation

When the hybrid ECU 91 determines that the engine operation condition is satisfied, the hybrid ECU 91 sets a target of the optimal engine torque TQopt and a target of the optimal engine speed NEopt for outputting the requested engine output Peng_req from the engine 10 as the target engine torque TQeng_tgt and the target engine speed NEtgt, respectively. In this case, the target engine torque TQeng_tgt and the target engine speed NEtgt are set to values larger than zero, respectively.

Further, the hybrid ECU 91 calculates the target first motor generator rotation speed NM1tgt on the basis of the target engine speed NEtgt and the second motor generator rotation speed NM2. In addition, the hybrid ECU 91 calculates the target first motor generator torque TQmg1_tgt on the basis of the target engine torque TQeng_tgt, the target first motor generator rotation speed NM1tgt, the first motor generator rotation speed NM1, and a distribution property of the engine torque by the driving force distribution mechanism 150. Hereinafter, the distribution property of the engine torque by the driving force distribution mechanism 150 will be referred to as “the torque distribution property”.

In addition, the hybrid ECU 91 calculates the target second motor generator torque TQmg2_tgt on the basis of the requested torque TQreq, the target engine torque TQeng_tgt, and the torque distribution property.

A method for calculating the target engine torque TQeng_tgt, the target engine speed NEtgt the target first motor generator torque TQmg1_tgt, the target first motor generator rotation speed NM1tgt and the target second motor generator torque TQmg2_tgt is known (for example, see JP 2013-177026 A).

The hybrid ECU 91 sends data of the target engine torque TQeng_tgt and the target engine speed NEtgt to the engine ECU 92 and data of the target first motor generator torque TQmg1_tgt and the target second motor generator torque TQmg2_tgt to the motor ECU 93.

When the engine ECU 92 receives the data of the target engine torque TQeng_tgt and the target engine speed NEtgt from the hybrid ECU 91, the engine ECU 92 controls the throttle valve 43, the fuel injectors 39, and the ignition device 37 to accomplish the target engine torque TQeng_tgt and the target engine speed NEtgt.

Further, the engine ECU 92 controls amounts of the fuel injected from the fuel injectors 39 on the basis of the air-fuel ratio A/Fu and the air-fuel ratio A/Fd such that an air-fuel ratio of a mixture gas formed in the combustion chambers 25 corresponds to the stoichiometric air-fuel ratio.

When the motor ECU 93 receives the data of the target first motor generator torque TQmg1_tgt and the target second motor generator torque TQmg2_tgt from the hybrid ECU 91, the motor ECU 93 controls the activations of the first motor generator 110 and the second motor generator 120 by controlling the activation of the inverter 130 to accomplish the target first motor generator torque TQmg1_tgt and the target second motor generator torque TQmg2_tgt.

Before a certain time elapses after the engine operation starts, the engine temperature Teng may be low. In this case, vaporization of the fuel is insufficient. Thus, the air-fuel ratio of the mixture gas is leaner than the stoichiometric air-fuel ratio if a target fuel injection amount Qtgt is set to control the air-fuel ratio of the mixture gas to the stoichiometric air-fuel ratio. As a result, the requested engine output Peng_req may not be output from the engine 10 or an accidental fire may occur.

Accordingly, the engine ECU 92 sets the target fuel injection amount Qtgt to control the air-fuel ratio of the mixture gas to be richer than the stoichiometric air-fuel ratio before a predetermined time elapses after the engine operation starts.

### Engine Operation Stop

When the hybrid ECU 91 determines that the engine operation stop condition is satisfied, the hybrid ECU 91 sets the target engine torque TQeng_tgt and the target engine speed NEtgt to zero, respectively.

In addition, the hybrid ECU 91 sets the target first motor generator torque TQmg1_tgt to zero and sets the second motor generator torque TQmg2 necessary to input the requested driving output Pdrv to the driving wheels 190 as the target second motor generator torque TQmg2_tgt.

The hybrid ECU 91 sends data of the target engine torque TQeng_tgt and the target engine speed NEtgt to the engine ECU 92 and sends the target first motor generator torque TQmg1_tgt and the target second motor generator torque TQmg2_tgt to the motor ECU 93.

When the engine ECU 92 receives the data of the target engine torque TQeng_tgt and the target engine speed NEtgt from the hybrid ECU 91, the engine ECU 92 controls the throttle valve 43, the fuel injectors 39, and the ignition device 37 to accomplish the target engine torque TQeng_tgt and the target engine speed NEtgt. In this case, the target engine torque TQeng_tgt and the target engine speed NEtgt are zero, respectively. Thus, the engine ECU 92 stops fuel injection operation by the fuel injectors 39 and ignition operation by the ignition device 37 and controls the throttle valve opening degree TA to zero.

When the motor ECU 93 receives the data of the target first motor generator torque TQmg1_tgt and the target second motor generator torque TQmg2_tgt from the hybrid ECU 91, the motor ECU 93 controls the first motor generator 110 and the second motor generator 120 by controlling the activation of the inverter 130 to accomplish the target first motor generator torque TQmg1_tgt and the target second motor generator torque TQmg2_tgt.

### Opening Timing of Intake Valves

Next, setting of the target opening timing Top_tgt and the like executed by the first embodiment apparatus when the ready switch 200 is set to the ON position, will be described. The target opening timing Top_tgt is a target of the intake valve opening timing Top.

In general, when the engine 10 operates, an amount of the air necessary to be suctioned into the combustion chambers 25, increases as the target engine speed NEtgt increases and the target engine torque TQeng_tgt increases.

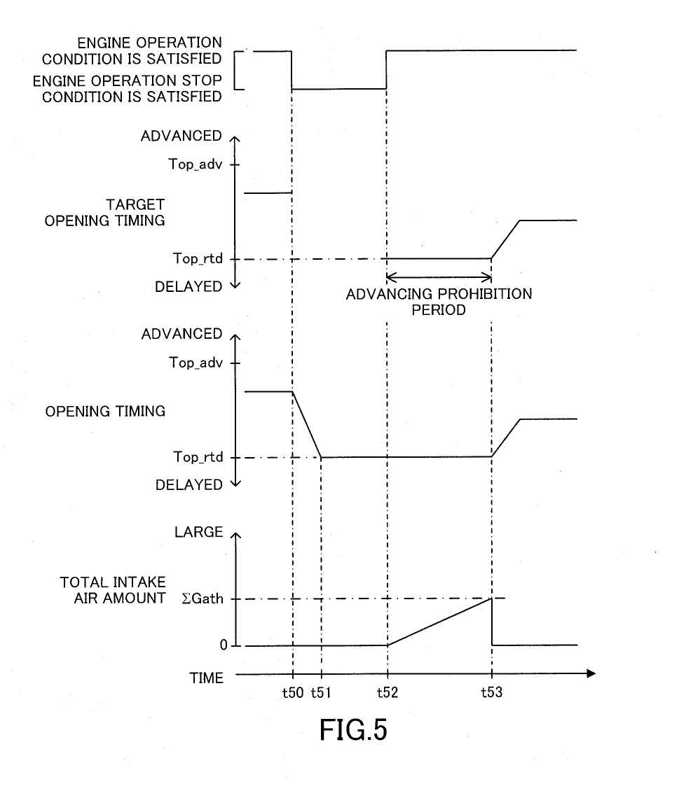

Accordingly, when the engine operation condition is satisfied (see a period before a timing t50 in FIG. 5), the engine ECU 92 sets the target opening timing Top_tgt on the basis of the target engine speed NEtgt and the target engine torque TQeng_tgt except for a period of prohibiting advancing of the opening timing of each of the intake valves 32 after the engine operation start as described later. In this case, the engine ECU 92 sets the target opening timing Top_tgt such that the target opening timing Top_tgt advances as the target engine speed NEtgt increases and sets the target opening timing Top_tgt advances as the target engine torque TQeng_tgt increases.

The engine ECU 92 controls the activation of the valve timing changing mechanism 33 to accomplish the target opening timing Top_tgt. Thereby, while the engine operation condition is satisfied, the intake valve opening timing Top is controlled, depending on the target engine speed NEtgt and the target engine torque TQeng_tgt except for the period of prohibiting the advancing of the opening timing of each of the intake valves 32.

After the engine operation stop condition is satisfied, the setting of the target opening timing Top_tgt is not performed. However, when the engine operation stop condition is satisfied (see the timing t50 in FIG. 5), the engine operation is stopped and thus, the hydraulic pressure Poil decreases. Therefore, the intake valve opening and closing timings Top and Tcl are set to the most delayed opening timing Top_rtd and the most delayed closing timing Tcl_rtd (see a timing t51 in FIG. 5).

Immediately after the engine operation starts after the engine operation is stopped, the engine temperature Teng is low and the fuel injection amount is increased to control the air-fuel ratio of the mixture gas to be richer than the stoichiometric air-fuel ratio. For the reasons, the fuel injected from the fuel injectors 39 is unlikely to vaporize. Therefore, a part of the injected fuel is likely to adhere to a wall surface defining the intake port 31 and/or a wall surface defining the combustion chamber 25. Hereinafter, the wall surface defining the intake port 31 and the wall surface defining the combustion chamber 25 will be collectively referred to as “the port wall surface and the like”.

Wall-adhering fuel (i.e., the fuel adhering to the port wall surface and the like) is unlikely to vaporize when the fuel removes from the port wall surface and the like. Therefore, the fuel adhering to the port wall surface and the like may not be burned in the combustion chambers 25 and thus, may be discharged from the combustion chambers 25 as unburned fuel. In order to prevent an amount of the unburned fuel discharged from the combustion chambers derived from the fuel adhering to the port wall surface and the like, from increasing, it is preferred to cause the wall-adhering fuel to remove from the port wall surface and the like and vaporize sufficiently.

In general, an intake air flow speed (i.e., a flow speed of the air suctioning into the combustion chambers 25) is high when the intake valve opening timing Top is delayed after the intake top dead center, compared with when the intake valve opening timing Top is advanced after the intake top dead center. The wall-adhering fuel is likely to remove from the port wall surface and the like and vaporize sufficiently when the intake air flow speed is high, compared with when the intake air flow speed is low.

In addition, when the intake valve closing timing Tcl is after the intake bottom dead center, the air is returned to the intake ports 31 from the combustion chambers 25 by the pistons 22 moving toward compression top dead centers. This returned air (i.e., the air returned to the intake ports 31) causes the wall-adhering fuel to remove from the port wall surface and the like and vaporize sufficiently. An amount of the wall-adhering fuel removed from the port wall surface and the like, increases as an amount of the returned air increases. In addition, the amount of the returned air is large when the intake valve closing timing Tcl is advanced after the intake bottom dead center, compared with when the intake valve closing timing Tcl is delayed after the intake bottom dead center.

Accordingly, when the engine operation condition is satisfied and a cool state condition that the engine temperature Teng is lower than the threshold engine temperature Teng_th after the engine operation stop is satisfied (see a timing t52 in FIG. 5), the hybrid ECU 91 starts to acquire a total intake air amount ΣGa. Before the total intake air amount ΣGa reaches a threshold intake air amount ΣGath (see an advancing prohibition period from the timing t52 to a timing t53 in FIG. 5), the hybrid ECU 91 prohibits the engine ECU 92 from advancing the intake valve opening timing Top. Thereby, before the total intake air amount ΣGa reaches the threshold intake air amount ΣGath after the engine operation condition is satisfied, the intake valve opening timing Top is maintained at the most delayed opening timing Top_rtd. In this regard, the threshold engine temperature Teng_th corresponds to the engine temperature Teng when the engine 10 is warmed completely. Therefore, when the engine temperature Teng is lower than the threshold engine temperature Teng_th, the engine 10 is warmed incompletely and is in a so-called cool state.

As described above, the intake air flow speed is high when the intake valve opening timing Top is delayed after the intake top dead center, compared with when the intake valve opening timing Top is advanced after the intake top dead center. In addition, the wall-adhering fuel is likely to remove from the port wall surface and the like and vaporize sufficiently when the intake air flow speed is high, compared with when the intake air flow speed is low.

The first embodiment apparatus prohibits the intake valve opening timing Top from being advanced until the total intake air amount ΣGa reaches the threshold intake air amount ΣGath after the engine operation starts. Therefore, the intake valve opening timing Top are maintained at a delayed timing after the intake top dead center, compared with when the intake valve opening timing Top is advanced. As a result, the intake air flow speed is maintained high. Thus, the wall-adhering fuel may be removed from the port wall surface and the like and vaporized sufficiently.

Further, the returned air may remove the wall-adhering fuel from the port wall surface and vaporize the removed fuel sufficiently. In addition, the amount of the wall-adhering fuel removed from the port wall surface and the like by the returned air, increases as the amount of the returned air increases. The amount of the returned air is large when the intake valve closing timing Tcl is delayed after the intake bottom dead center, compared with when the intake valve closing timing Tcl is advanced after the intake bottom dead center.

The first embodiment apparatus prohibits the intake valve closing timing Tcl from being advanced until the total intake air amount ΣGa reaches the threshold intake air amount ΣGath after the engine operation starts. Therefore, the intake valve closing timing Tcl is maintained at a delayed timing after the intake bottom dead center, compared with when the intake valve closing timing Tcl is advanced. As a result, the amount of the returned air is maintained large. Thus, the large amount of the wall-adhering fuel may remove from the port wall surface and the like and vaporize sufficiently.

As described above, the wall-adhering fuel removes from the port wall surface and the like and vaporizes sufficiently. Thus, the large amount of the unburned fuel may be prevented from being discharged from the combustion chambers 25. In addition, the fuel removed from the port wall surface and the like burns sufficiently in the combustion chambers 25. Thus, a fuel consumption may be prevented from increasing.

Therefore, according to the first embodiment apparatus, the large amount of the unburned fuel may be prevented from being discharged from the combustion chambers 25 and the fuel consumption may be prevented from increasing without adding new parts and/or new controls.

When the water temperature THW at a time of the engine operation condition being satisfied, is low, the fuel injected from the fuel injectors 39 is unlikely to vaporize, compared with when the water temperature THW is high. In other words, when the engine temperature Teng at the time of the engine operation condition being satisfied, is low, the fuel injected from the fuel injectors 39 is unlikely to vaporize, compared with the engine temperature Teng is high.

Further, the fuel injected from the fuel injectors 39 is unlikely to vaporize when the fuel injection amount is large at the time of the engine operation condition being satisfied, compared with when the fuel injection amount is small at the time of the engine operation condition being satisfied.

Accordingly, the hybrid ECU 91 sets the threshold intake air amount ΣGath to a large value when an engine operation starting water temperature THWst (i.e., the water temperature THW when the engine operation condition is satisfied, that is, the engine operation starts) is low, compared with when the engine operation starting water temperature THWst is high. In other words, the hybrid ECU 91 sets the threshold intake air amount ΣGath to a large value when the engine temperature Teng is low, compared with when the engine temperature Teng is high.

In addition, the hybrid ECU 91 sets the threshold intake air amount ΣGath to a large value when an engine operation starting target fuel injection amount Qtgt_st (i.e., the target fuel injection amount Qtgt when the engine operation condition is satisfied, that is, the engine operation starts) is large, compared with when the engine operation starting target fuel injection amount Qtgt_st is small.

In particular, the hybrid ECU 91 sets the threshold intake air amount ΣGath such that the threshold intake air amount ΣGath increases as the engine operation starting water temperature THWst decreases and the engine operation starting target fuel injection amount Qtgt_st increases.

The threshold intake air amount ΣGath is set to an amount capable of maintaining the amount of the unburned fuel discharged from the combustion chambers 25 at an amount equal to or smaller than an optionally set permitted upper limit.

When the total intake air amount ΣGa reaches the threshold intake air amount ΣGath after the engine operation condition is first satisfied (see a timing t53 in FIG. 5), the hybrid ECU 91 permits the engine ECU 92 to advance the intake valve opening timing Top. Thereby, the engine ECU 92 sets the target opening timing Top_tgt on the basis of the target engine speed NEtgt and the target engine torque TQeng_tgt and controls the activation of the valve timing changing mechanism 33 to accomplish the target opening timing Top_tgt. Thus, after the total intake air amount ΣGa reaches the threshold intake air amount ΣGath after the engine operation condition is satisfied, the intake valve opening timing Top is controlled, depending on the target engine speed NEtgt and the target engine torque TQeng_tgt.

### Concrete Operation of First Embodiment Apparatus

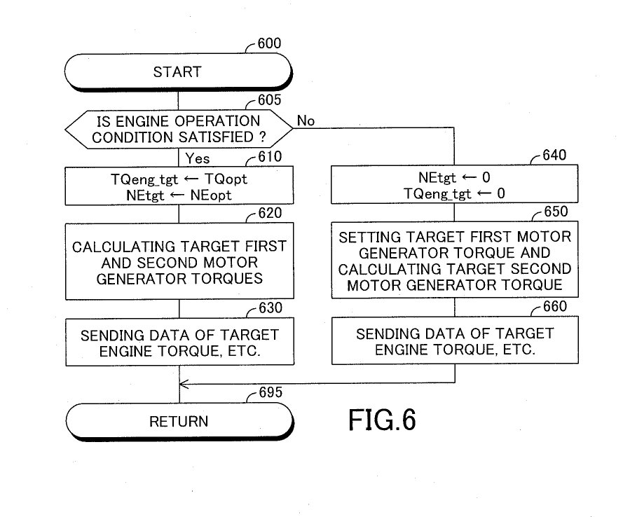

Next, a concrete operation of the first embodiment apparatus will be described. The CPU of the hybrid ECU 91 of the first embodiment apparatus is configured or programmed to execute a routine shown by a flowchart in FIG. 6 each time a predetermined time elapses.

Therefore, at a predetermined timing, the CPU starts a process from a step 600 of FIG. 6 and then, proceeds with the process to a step 605 to determine whether the engine operation condition is satisfied. When the engine operation condition is satisfied, the CPU determines “Yes” at the step 605 and then, sequentially executes processes of steps 610 to 630 described below. Then, the CPU proceeds with the process to a step 695 to terminate this routine once.

Step 610: The CPU sets the optimal engine torque TQopt and the optimal engine speed NEopt selected as described above as the target engine torque TQeng_tgt and the target engine speed NEtgt, respectively.

Step 620: The CPU calculates the target first motor generator torque TQmg1_tgt and the target second motor generator torque TQmg2_tgt as described above, using the target engine torque TQeng_tgt set at the step 610.

Step 630: The CPU sends the data of the target engine torque TQeng_tgt and the target engine speed NEtgt set at the step 610 to the engine ECU 92 and sends the data of the target first motor generator torque TQmg1_tgt and the target second motor generator torque TQmg2_tgt calculated at the step 620 to the motor ECU 93.

When the engine ECU 92 receives the data of the target engine torque TQeng_tgt and the target engine speed NEtgt, the engine ECU 92 controls the activations of the throttle valve 43, the fuel injectors 39, and the ignition device 37 to accomplish the target engine torque TQeng_tgt and the target engine speed NEtgt on the basis of the received data.

When the motor ECU 93 receives the data of the target first motor generator torque TQmg1_tgt and the target second motor generator torque TQmg2_tgt, the motor ECU 93 controls the activations of the first motor generator 110 and the second motor generator 120 by controlling the activation of the inverter 130 to accomplish the target first motor generator torque TQmg1_tgt and the target second motor generator torque TQmg2_tgt on the basis of the received data.

When the engine operation condition is not satisfied, that is, when the engine operation stop condition is satisfied at a time of the CPU executing the process of the step 605, the CPU determines “No” at the step 605 and then, sequentially executes processes of steps 640 to 660 described below. Then, the CPU proceeds with the process to the step 695 to terminate this routine once.

Step 640: The CPU sets the target engine torque TQeng_tgt and the target engine speed NEtgt to zero, respectively.

Step 650: The CPU sets the first motor generator torque TQmg1 to zero and calculates the target second motor generator torque TQmg2_tgt as described above.

Step 660: The CPU sends the data of the target engine torque TQeng_tgt and the target engine speed NEtgt set at the step 640 to the engine ECU 92 and sends the data of the target first motor generator torque TQmg1_tgt set at the step 650 and the target second motor generator torque TQmg2_tgt calculated at the step 650 to the motor ECU 93.

When the engine ECU 92 receives the data of the target engine torque TQeng_tgt and the target engine speed NEtgt, the engine ECU 92 controls the activations of the throttle valve 43, the fuel injectors 39, and the ignition device 37 to accomplish the target engine torque TQeng_tgt and the target engine speed NEtgt on the basis of the received data. In this case, the target engine torque TQeng_tgt and the target engine speed NEtgt are zero, respectively. Thus, the fuel injectors 39 and the ignition device 37 are not activated, and the throttle valve opening degree TA is controlled to zero.

When the motor ECU 93 receives the data of the target first motor generator torque TQmg1_tgt and the target second motor generator torque TQmg2_tgt, the motor ECU 93 controls the activations of the first motor generator 110 and the second motor generator 120 by controlling the activation of the inverter 130 to accomplish the target first motor generator torque TQmg1_tgt and the target second motor generator torque TQmg2_tgt on the basis of the received data.

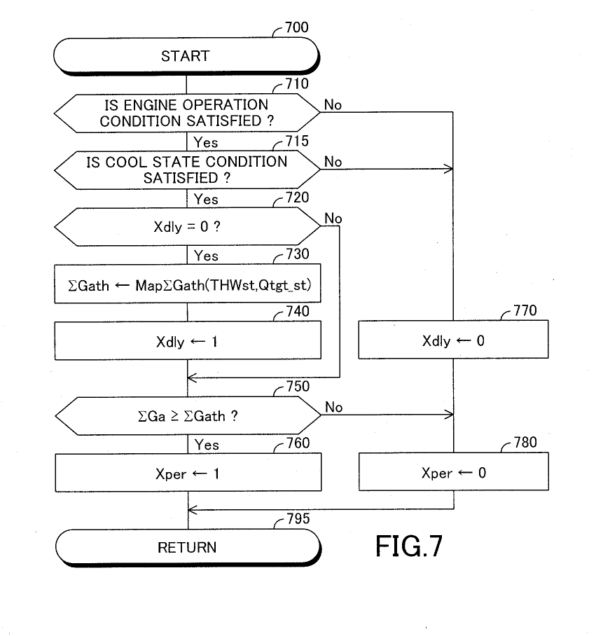

Further, the CPU is configured or programmed to execute a routine shown by a flowchart in FIG. 7 each time the predetermined time elapses. Therefore, at a predetermined timing, the CPU starts a process from a step 700 and then, proceeds with the process to a step 710 to determine whether the engine operation condition is satisfied. When the engine operation condition is satisfied, the CPU determines “Yes” at the step 710 and then, proceeds with the process to a step 715 to determine whether the cool state condition is satisfied.

When the cool state condition is satisfied, the CPU determines “Yes” at the step 715 and then, proceeds with the process to a step 720 to determine whether a value of a delay flag Xdly is “0”.

The delay flag Xdly indicates whether the present time is a time of the engine operation condition being first satisfied after the engine operation condition is not satisfied, that is, after the engine operation stop condition is satisfied. When the value of the delay flag Xdly is “0”, the delay flag Xdly indicates that the present time is a time of the engine operation condition being first satisfied after the engine operation stop condition is satisfied. On the other hand, when the value of the delay flag Xdly is “1”, the delay flag Xdly indicates that the present time is not the time of the engine operation condition being first satisfied after the engine operation stop condition is satisfied. The value of the delay flag Xdly is set to “1” at a step 740 described later and is set to “0” at a step 770 described later.

Immediately after the engine operation condition is first satisfied after the engine operation stops, the value of the delay flag Xdly is “0”. Therefore, in this case, the CPU determines “Yes” at the step 720 and then, sequentially executes processes of steps 730 and 740 described below. Then, the CPU proceeds with the process to a step 750.

Step 730: The CPU applies the engine-operation-starting water temperature THWst and the engine-operation-starting target fuel injection amount Qtgt_st to a look-up table MapΣGa(THWst, Qtgt_st) to acquire the threshold intake air amount ΣGath. According to the look-up table MapΣGa(THWst, Qtgt_st), the threshold intake air amount ΣGath increases as the engine-operation-starting water temperature THWst increases and the engine-operation-starting target fuel injection amount Qtgt_st increases.

Step 740: The CPU sets the value of the delay flag Xdly to “1”.

When the CPU proceeds with the process to the step 720 after the CPU sets the value of the delay flag Xdly to “1”, the CPU determines “No” at the step 720 and then, proceeds with the process to a step 750.

When the CPU proceeds with the process to the step 750, the CPU determines whether the total intake air amount ΣGa is equal to or larger than the threshold intake air amount ΣGath acquired at the step 730. It should be noted that the total intake air amount ΣGa is a total amount of the air suctioned into the combustion chambers 25 after the engine operation condition is first satisfied.

When the present time is immediately after the engine operation condition is first satisfied after the engine operation is stopped, the total intake air amount ΣGa is smaller than the threshold intake air amount ΣGath. Therefore, in this case, the CPU determines “No” at the step 750 and then, executes a process of a step 780 described below. Then, the CPU proceeds with the process to a step 795 to terminate this routine once.

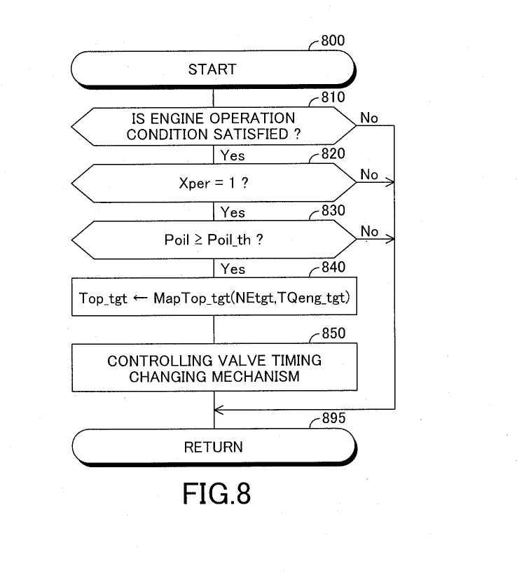

Step 780: The CPU sets a value of an advancing permission flag Xper to “0”. The advancing permission flag Xper is used at a step 820 of FIG. 8 described later.

The advancing permission flag Xper indicates whether the intake valve opening timing Top is permitted to be advanced. When the value of the advancing permission flag Xper is “0” the intake valve opening timing Top is prohibited from being advanced. On the other hand, when the value of the advancing permission flag Xper is “1”, the intake valve opening timing Top is permitted to be advanced.

When the total intake air amount ΣGa is equal to or larger than the threshold intake air amount ΣGath, the CPU determines “Yes” at the step 750 and then, executes a process of a step 760 described below. Then, the CPU proceeds with the process to the step 795 to terminate this routine once.

Step 760: The CPU sets the value of the advancing permission flag Xper to “1”.

When the engine operation condition is not satisfied, that is, when the engine operation stop condition is satisfied at a time of the CPU executing the process of the step 710, the CPU determines “No” at the step 710 and then, sequentially executes a process of a step 770 described below and the process of the step 780 described above. Then, the CPU proceeds with the process to the step 795 to terminate this routine once.

Step 770: The CPU sets the value of the delay flag Xdly to “0”.

Further, when the cool state condition is not satisfied at a time of the CPU executing the process of the step 715, the CPU determines “No” at the step 715 and then, sequentially executes the processed of the steps 770 and 780 described above. Then, the CPU proceeds with the process to the step 795 to terminate this routine once.

Further, the CPU of the engine ECU 92 of the first embodiment apparatus is configured or programmed to execute a routine shown by a flowchart in FIG. 8 each time the predetermined time elapses. Therefore, at a predetermined timing, the CPU starts a process from a step 800 and then, proceeds with the process to a step 810 to determine whether the engine operation condition is satisfied. When the engine operation condition is satisfied, the CPU determines “Yes” at the step 810 and then, proceeds with the process to a step 820 to determine whether the value of the advancing permission flag Xper is “1”.

When the value of the advancing permission flag Xper is “1”, the CPU determines “Yes” at the step 820 and then, proceeds with the process to a step 830 to determine whether the hydraulic pressure Poil is equal to or larger than the threshold hydraulic pressure Poil_th. The threshold hydraulic pressure Poil_th is set to a lower limit of the hydraulic pressure capable of activating the valve timing changing mechanism 33.

When the hydraulic pressure Poil is equal to or larger than the threshold hydraulic pressure Poil_th, the CPU determines “Yes” at the step 830 and then, sequentially executes processes of steps 840 and 850 described below. Then, the CPU proceeds with the process to a step 895 to terminate this routine once.

Step 840: The CPU applies the target engine speed NEtgt and the target engine torque TQeng_tgt to a look-up table MapTop_tgt(NEtgt, TQeng_tgt) to acquire or set the target opening timing Top_tgt.

Step 850: The CPU controls the activation of the valve timing changing mechanism 33 such that the intake valve opening timing Top corresponds to the target opening timing Top_tgt. Thereby, the intake valve opening and closing timings Top and Tcl are controlled, depending on the engine speed NE and the engine load KL.

When the value of the advancing permission flag Xper is “0” at a time of the CPU executing the process of the step 820 and when the hydraulic pressure Poil is smaller than the threshold hydraulic pressure Poil_th at a time of the CPU executing the process of the step 830, the CPU determines “No” at the steps 820 and 830, respectively and then, proceeds with process directly to the step 895 to terminate this routine once. In this case, the intake valve opening and closing timings Top and Tcl are the most delayed opening timing Top_rtd and the most delayed closing timing Tcl_rtd, respectively.

When the engine operation condition is not satisfied, that is, when the engine operation stop condition is satisfied at a time of the CPU executing the process of the step 810, the CPU determines “No” at the step 810 and then, proceeds with the process directly to the step 895 to terminate this routine once. In this case, the engine operation is stopped. Thus, the hydraulic pressure Poil decreases and as a result, the intake valve opening and closing timings Top and Tcl are the most delayed opening timing Top_rtd and the most delayed closing timing Tcl_rtd, respectively.

The concrete operation of the first embodiment apparatus has been described. Thereby, when the cool state condition is satisfied at the time of the engine operation condition being satisfied (see the determinations “Yes” at the steps 710 and 715), the intake valve opening and closing timings Top and Tcl are the most delayed opening timing Top_rtd and the most delayed closing timing Tcl_rtd, respectively until the total intake air amount ΣGa reaches the threshold intake air amount ΣGath (until the CPU determines “Yes” at the step 750). Thus, a large amount of the wall-adhering fuel may remove from the port wall surface and the like and vaporize sufficiently.

### Second Embodiment

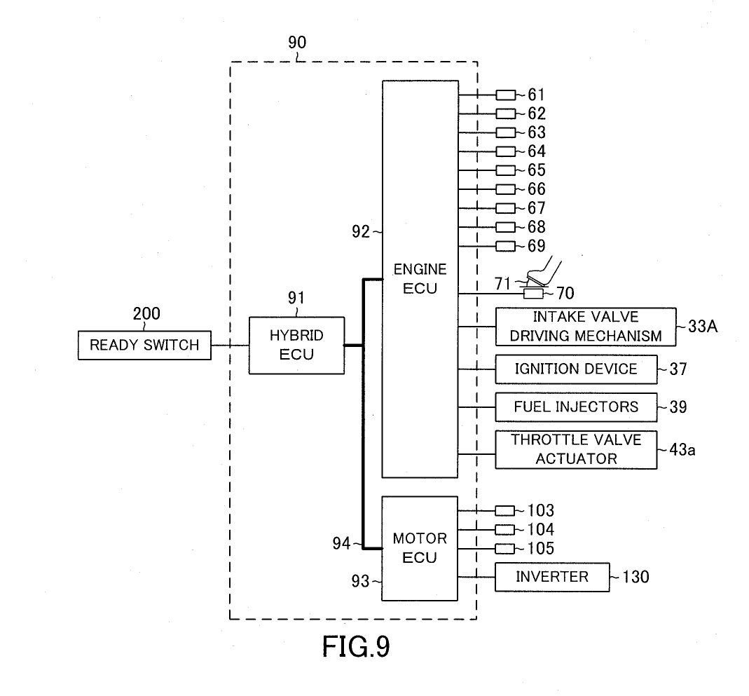

Next, the control apparatus of the engine 10 according to the second embodiment of the invention, will be described. As shown in FIG. 9, the cylinder head portion 30 of the engine 10, to which the control apparatus according to the second embodiment is applied, includes an intake valve driving mechanism 33A in place of the valve timing changing mechanism 33 of the cylinder head portion 30 of the engine 10, to which the first embodiment apparatus is applied. Hereinafter, the control apparatus according to the second embodiment will be referred to as “the second embodiment apparatus”.

The intake valve driving mechanism 33A is a mechanism for opening and closing the intake valves 32 by electromagnetic force. The intake valve driving mechanism 33A controls the intake valve opening and closing timings Top and Tcl, independently.

The intake valve driving mechanism 33A controls the intake valve opening timing Top in a rage between a most delayed opening timing Top_rtd (i.e., a predetermined timing after the intake top dead center) and a most advanced opening timing Top_adv (i.e., a predetermined timing before the most delayed opening timing Top_rtd).

Further, the intake valve driving mechanism 33A controls the intake valve closing timing Tcl in a range between a most delayed closing timing Tcl_rtd (i.e., a predetermined timing after the most delayed opening timing Top_rtd) and a most advanced closing timing Tcl_adv (i.e., a predetermined timing before the most delayed closing timing Tcl_rtd and after the most advanced opening timing Top_adv).

The intake valve driving mechanism 33A is electrically connected to the engine ECU 92. The intake valve driving mechanism 33A drives the intake valves 32 such that the intake valves 32 open at the target opening timing Top_tgt sent from the hybrid ECU 91 as described later. Further, the intake valve driving mechanism 33A drives the intake valves 32 such that the intake valves 32 is closed at the target closing timing Tcl_tgt sent from the hybrid ECU 91 as described later.

### Summary of Operation of Second Embodiment Apparatus

Next, a summary of an operation of the second embodiment apparatus will be described. The hybrid ECU 91 of the second embodiment apparatus sets the target engine torque TQeng_tgt and the target engine speed NEtgt similar to the first embodiment apparatus and sends the data of the target engine torque TQeng_tgt and the target engine speed NEtgt to the engine ECU 92, and sets the target first motor generator torque TQmg1_tgt and the target second motor generator torque TQmg2_tgt similar to the first embodiment apparatus and sends the data of the target first motor generator torque TQmg1_tgt and the target second motor generator torque TQmg2_tgt to the motor ECU 93.

Similar to the first embodiment apparatus, the engine ECU 92 of the second embodiment apparatus controls the activations of the throttle valve 43, the fuel injectors 39, and the ignition device 37 to accomplish the target engine torque TQeng_tgt and the target engine speed NEtgt on the basis of the received data.

Similar to the first embodiment apparatus, the motor ECU 93 of the second embodiment apparatus controls the activations of the first motor generator 110 and the second motor generator 120 to accomplish the target first motor generator torque TQmg1_tgt and the target second motor generator torque TQmg2_tgt on the basis of the received data.

Further, similar to the first embodiment apparatus, when the cool state condition is satisfied at the time of the engine operation condition being satisfied after the engine operation stop condition is satisfied, the hybrid ECU 91 of the second embodiment apparatus prohibits the engine ECU 92 from advancing the intake valve opening and closing timings Top and Tcl until the total intake air amount ΣGa reaches the threshold intake air amount ΣGath.

In this embodiment, when the engine operation condition is satisfied, the hybrid ECU 91 of the second embodiment apparatus is configured to set the intake valve opening and closing timings Top and Tcl to the most delayed opening timing Top_rtd and the most delayed closing timing Tcl_rtd, respectively. Thereby, when the cool state condition is satisfied at the time of the engine operation condition being satisfied, the intake valve opening and closing timings Top and Tcl are maintained at the most delayed opening timing Top_rtd and the most delayed closing timing Tcl_rtd, respectively until the total intake air amount ΣGa reaches the threshold intake air amount ΣGath.

According to the second embodiment apparatus, similar to the first embodiment apparatus, the large amount of the wall-adhering fuel may remove from the port wall surface and the like and vaporize sufficiently.

Further, similar to the first embodiment apparatus, when the engine-operation-starting water temperature THWst is low, the hybrid ECU 91 of the second embodiment apparatus sets the threshold intake air amount ΣGath to a large value, compared with when the water temperature THW is high. In addition, when the engine-operation-starting target fuel injection amount Qtgt_st is large, the hybrid ECU 91 of the second embodiment apparatus sets the threshold intake air amount ΣGath to a large value, compared with when the engine-operation-starting target fuel injection amount Qtgt_st is small.

When the total intake air amount ΣGa reaches the threshold intake air amount ΣGath, the hybrid ECU 91 of the second embodiment apparatus permits the engine ECU 92 to advance the intake valve opening and closing timings Top and Tcl.

In this case, similar to the first embodiment apparatus, the engine ECU 92 of the second embodiment apparatus sets the target opening timing Top_tgt and the target closing timing Tcl_tgt on the basis of the target engine speed NEtgt and the target engine torque TQeng_tgt. Then, the engine ECU 92 of the second embodiment apparatus controls the activation of the intake valve driving mechanism 33A to accomplish the target opening timing Top_tgt and the target closing timing Tcl_tgt.

Further, when the engine operation stop condition is satisfied, the hybrid ECU 91 of the second embodiment apparatus sets the intake valve opening and closing timings Top and Tcl to the most delayed opening timing Top_rtd and the most delayed closing timing Tcl_rtd, respectively. Thus, when the engine operation is stopped, the intake valve opening and closing timings Top and Tcl are controlled to the most delayed opening timing Top_rtd and the most delayed closing timing Tcl_rtd, respectively.

### Concrete Operation of Second Embodiment Apparatus

Next, a concrete operation of the second embodiment apparatus will be described. The CPU of the hybrid ECU 91 of the second embodiment apparatus is configured or programmed to execute the routine shown in FIG. 6 described above for sending the data of the target engine torque TQeng_tgt and the like to the engine ECU 92 each time the predetermined time elapses. Further, the CPU of the second embodiment apparatus is configured or programmed to execute the routine shown in FIG. 7 described above for setting the value of the delay flag Xdly each time the predetermined time elapses.

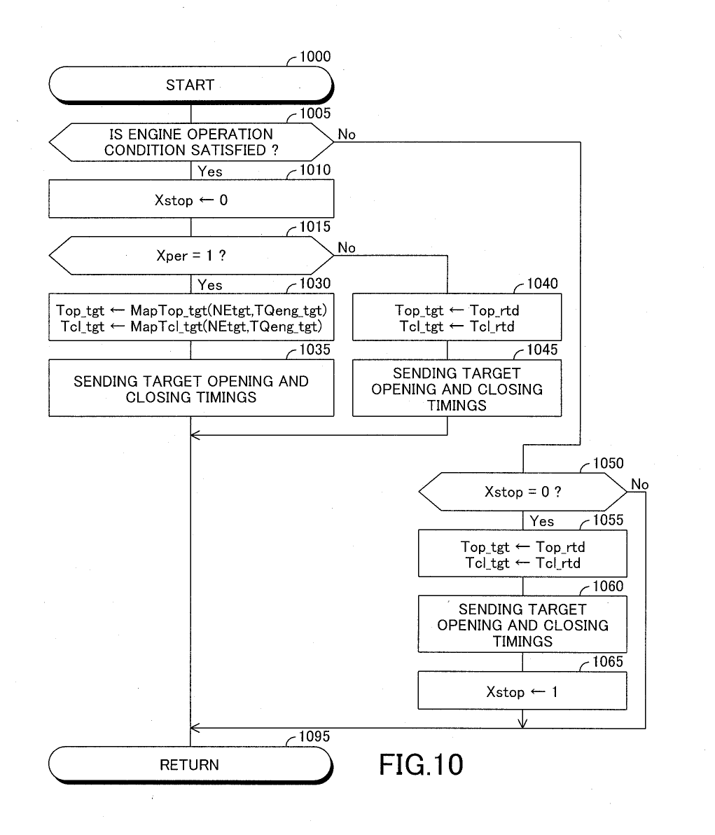

Further, the CPU of the second embodiment apparatus is configured or programmed to execute a routine shown by a flowchart in FIG. 10 each time the predetermined time elapses. Therefore, at a predetermined timing, the CPU of the second embodiment apparatus starts a process from a step 1000 and then, proceeds with the process to a step 1005 to determine whether the engine operation condition is satisfied. When the engine operation condition is satisfied, the CPU of the second embodiment apparatus determines “Yes” at the step 1005 and then, executes a process of a step 1010 described below. Then, the CPU proceeds with the process to a step 1015.

Step 1010: The CPU sets a value of a stop process flag Xstop to “0”. The stop process flag Xstop is used at a step 1050 described later.

The stop process flag Xstop indicates whether the engine operation continues to be stopped after a most delaying process for controlling the intake valve opening timing Top to the most delayed opening timing Top_rtd, is performed at a time of the engine operation being stopped. When the value of the stop process flag Xstop is “0”, the stop process flag Xstop indicates that the engine operation does not continue to be stopped, that is, the engine 10 operates. On the other hand, when the value of the stop process flag Xstop is “1”, the stop process flag Xstop indicates that the engine operation continues to be stopped after the most delay process is performed at the time of the engine operation being stopped.

When the CPU of the second embodiment apparatus proceeds with the process to the step 1015, the CPU of the second embodiment apparatus determines whether the value of the advancing permission flag Xper is “1”. When the value of the advancing permission flag Xper is “1”, the CPU of the second embodiment apparatus determines “Yes” at the step 1015 and then, sequentially executes processes of steps 1030 and 1035 described below. Then, the CPU of the second embodiment apparatus proceeds with the process to a step 1095 to terminate this routine once.

Step 1030: The CPU of the second embodiment apparatus applies the target engine speed NEtgt and the target engine torque TQeng_tgt to a look-up table MapTop_tgt(NEtgt, TQeng_tgt) to acquire or set the target opening timing Top_tgt. In addition, the CPU of the second embodiment apparatus applies the target engine speed NEtgt and the target engine torque TQeng_tgt to a look-up table MapTcl_tgt(NEtgt, TQeng_tgt) to acquire or set the target closing timing Tcl_tgt.

Step 1035: The CPU of the second embodiment apparatus sends the target opening timing Top_tgt and the target closing timing Tcl_tgt acquired at the step 1030 to the intake valve driving mechanism 33A. In this case, the intake valve driving mechanism 33A activates the intake valves 32 such that each of the intake valves 32 opens at the target opening timing Top_tgt and is closed at the target closing timing Tcl_tgt. Thereby, the intake valve opening and closing timings Top and Tcl are controlled, depending on the engine speed NE and the engine load KL.

When the value of the advancing permission flag Xper is “0” at a time of the CPU of the second embodiment apparatus executing the process of the step 1015, the CPU of the second embodiment apparatus determines “No” at the step 1015 and then, sequentially executes processes of steps 1040 and 1045 described below. Then, the CPU of the second embodiment apparatus proceeds with the process to the step 1095 to terminate this routine once.

Step 1040: The CPU of the second embodiment apparatus sets the target opening timing Top_tgt to the most delayed opening timing Top_rtd and the target closing timing Tcl_tgt to the most delayed closing timing Tcl_rtd.

Step 1045: The CPU of the second embodiment apparatus sends the target opening timing Top_tgt and the target closing timing Tcl_tgt set at the step 1040 to the intake valve driving mechanism 33A. In this case, the intake valve driving mechanism 33A activates the intake valves 32 such that each of the intake valves 32 opens at the target opening timing Top_tgt (i.e., the most delayed opening timing Top_rtd) and is closed at the target closing timing Tcl_tgt (i.e., the most delayed closing timing Tcl_rtd).

When the engine operation condition is not satisfied, that is, when the engine operation stop condition is satisfied at a time of the CPU of the second embodiment apparatus executing the process of the step 1005, the CPU of the second embodiment apparatus determines “No” at the step 1005 and then, proceeds with the process to a step 1050 to determine whether the value of the stop process flag Xstop is “0”.

The value of the stop process flag Xstop is “0” immediately after the engine operation stop condition is satisfied. Therefore, in this case, the CPU of the second embodiment apparatus determines “Yes” at the step 1050 and then, sequentially executes processes of steps 1055 to 1065 described below. Then, the CPU of the second embodiment apparatus proceeds with the process to the step 1095 to terminate this routine once.

Step 1055: The CPU of the second embodiment apparatus sets the target opening timing Top_tgt to the most delayed opening timing Top_rtd and the target closing timing Tcl_tgt to the most delayed closing timing Tcl_rtd.

Step 1060: The CPU sends the target opening timing Top_tgt and the target closing timing Tcl_tgt set at the step 1055 to the intake valve driving mechanism 33A. In this case, the intake valve driving mechanism 33A activates the intake valves 32 such that each of the intake valves 32 opens at the target opening timing Top_tgt (i.e., the most delayed opening timing Top_rtd) and is closed at the target closing timing Tcl_tgt (i.e., the most delayed closing timing Tcl_rtd).

Step 1065: The CPU of the second embodiment apparatus sets the value of the stop process flag Xstop to “1”.

After the CPU of the second embodiment apparatus sets the value of the stop process flag Xstop to “1” at the step 1065, the CPU of the second embodiment apparatus determines “No” at the step 1050. In this case, the CPU of the second embodiment apparatus proceeds with the process directly to the step 1095 to terminate this routine once.

The concrete operation of the second embodiment apparatus has been described. Thereby, when the cool state condition is satisfied at the time of the engine operation condition being satisfied (the CPU of the second embodiment apparatus determines “Yes” at the steps 710 and 715, respectively), the intake valve opening and closing timings Top and Tcl are controlled to the most delayed opening timing Top_rtd and the most delayed closing timing Tcl_rtd (see the process of the step 1040) until the total intake air amount ΣGa reaches the threshold intake air amount ΣGath (until the CPU of the second embodiment apparatus determines “Yes” at the step 750). Thus, the large amount of the wall-adhering fuel may remove from the port wall surface and the like and vaporize sufficiently.

It should be noted that the present invention is not limited to the aforementioned embodiment, and various modifications can be employed within the scope of the present invention.

For example, the first and second embodiment apparatuses prohibit the intake valve opening and closing timings Top and Tcl from being advanced when the engine operation condition and the cool state condition are satisfied. In this regard, the first and second embodiment apparatuses may be configured to prohibit the intake valve opening and closing timings Top and Tcl from being advanced when the engine operation is satisfied, independently of the cool state condition.

Further, the second embodiment apparatus controls the intake valve opening and closing timings Top and Tcl to the most delayed opening timing Top_rtd and the most delayed closing timing Tcl_rtd, respectively when the engine operation starts. In this regard, the second embodiment apparatus may be configured to control the intake valve opening and closing timings Top and Tcl to timings before the most delayed opening timing Top_rtd and the most delayed closing timing Tcl_rtd, respectively when the engine operation starts.

Further, as an after-engine-start elapsing time (i.e., a time elapsing from the engine operation starting) increases, the total intake air mount ΣGa increases. Therefore, the after-engine-start elapsing time correlates with the total intake air mount ΣGa. Accordingly, the first and second embodiment apparatuses may be configured to use the after-engine-start elapsing time as a value correlating with the total intake air mount ΣGa.

Further, as the total intake air mount ΣGa increases, a total fuel injection amount (i.e., a total amount of the fuel injected from the fuel injectors 39 after the engine operation starts) increases. Therefore, the total fuel injection amount correlates with the total intake air mount ΣGa. Accordingly, the first and second embodiment apparatuses may be configured to use the total fuel injection amount as a value correlating with the total intake air mount ΣGa.

Further, the first and second embodiment apparatuses are configured to permit the intake valve opening timing Top to be advanced when the total intake air mount ΣGa reaches the threshold intake air mount ΣGath. In this regard, the first and second embodiment apparatuses may be configured to permit the intake valve opening timing Top to be advanced at a timing after the total intake air mount ΣGa reaches the threshold intake air mount ΣGath. Therefore, the first and second embodiment apparatuses may be configured to permit the intake valve opening timing Top to be advanced when or after the total intake air mount ΣGa reaches the threshold intake air mount ΣGath.

Further, the valve timing changing mechanism 33 may be configured to control the most advanced opening timing Top_adv, the most delayed opening timing Top_rtd, the most advanced closing timing Tcl_adv, and the most delayed closing timing Tcl_rtd such that a difference ΔTop between the most advanced opening timing Top_adv and the most delayed opening timing Top_rtd is equal to or different from a difference ΔTcl between the most advanced closing timing Tcl_adv and the most delayed closing timing Tcl_rtd.

What is claimed is:

1. A control apparatus of an internal combustion engine, comprising an electronic control unit for controlling an opening timing of each of intake valves of the internal combustion engine, depending on an operation state of the internal combustion engine after an engine operation corresponding to an operation of the internal combustion engine, starts,
wherein the electronic control unit is configured to:
control the opening timing to a predetermined opening timing after an intake top dead center when the engine operation starts;
acquire a total intake air amount correlation value correlating with a total amount of air suctioned into combustion chambers of the internal combustion engine after the engine operation starts, the total air amount correlation value increasing as the total amount increases;
prohibit the opening timing from advancing from the predetermined opening timing until the total intake air amount correlation value reaches a threshold after the engine operation starts; and
permit the opening timing to advance from the predetermined opening timing after the total intake air amount correlation value reaches the threshold after the engine operation starts.

2. The control apparatus according to claim 1, wherein the electronic control unit is configured to:
control the opening timing in a predetermined first range in which a most delayed opening timing is after the intake top dead center; and
set the predetermined opening timing to the most delayed opening timing of the predetermined first range when the engine operation starts and control the opening timing to the predetermined opening timing.

3. The control apparatus according to claim 1, wherein the electronic control unit is configured to:
control a closing timing of each of the intake valves, depending on the operation state of the internal combustion engine after the engine operation starts;
control the closing timing to a predetermined closing timing after an intake bottom dead center when the engine operation starts;
prohibit the closing timing from advancing from the predetermined closing timing until the total intake air amount correlation value reaches the threshold after the engine operation starts; and
permit the closing timing to advance from the predetermined closing timing after the total intake air amount correlation value reaches the threshold after the engine operation starts.

4. The control apparatus according to claim 3, wherein the electronic control unit is configured to:
control the closing timing in a predetermined second range in which a most delayed closing timing is after the intake bottom dead center; and
set the predetermined closing timing to the most delayed closing timing of the predetermined second range when the engine operation starts and control the closing timing to the predetermined opening timing.

5. The control apparatus according to claim 1, wherein the electronic control unit is configured to set the threshold to a large value when a temperature of the internal combustion engine is low at a time of the engine operation starting, compared with when the temperature of the internal combustion engine is high at the time of the engine operation starting.

6. The control apparatus according to claim 1, wherein the electronic control unit is configured to set the threshold to a large value when an amount of fuel supplied to the combustion chambers is large at a time of the engine operation starting, compared with when the amount of the fuel supplied to the combustion chambers is small at the time of the engine operation starting.

7. A control apparatus of an internal combustion engine, comprising an electronic control unit for controlling a closing timing of each of intake valves of the internal combustion engine, depending on an operation state of the internal combustion engine after an engine operation corresponding to an operation of the internal combustion engine, starts,
wherein the electronic control unit is configured to:
control the closing timing to a predetermined closing timing after an intake bottom dead center when the engine operation starts;
acquire a total intake air amount correlation value correlating with a total amount of air suctioned into combustion chambers of the internal combustion engine after the engine operation starts, the total air amount correlation value increasing as the total amount increases;
prohibit the closing timing from advancing from the predetermined closing timing until the total intake air amount correlation value reaches a threshold after the engine operation starts; and
permit the closing timing to advance from the predetermined closing timing after the total intake air amount correlation value reaches the threshold after the engine operation starts.

8. The control apparatus according to claim 7, wherein the electronic control unit is configured to set the threshold to a large value when a temperature of the internal combustion engine is low at a time of the engine operation starting, compared with when the temperature of the internal combustion engine is high at the time of the engine operation starting.

9. The control apparatus according to claim 7, wherein the electronic control unit is configured to set the threshold to a large value when an amount of fuel supplied to the combustion chambers is large at a time of the engine operation starting, compared with when the amount of the fuel supplied to the combustion chambers is small at the time of the engine operation starting.
